(19) United States
(12) Patent Application Publication
(10) Pub. No.: US 2019/0152595 A1
(43) Pub. Date: May 23, 2019

(54) Apparatus for Sustained Surveillance and Deterrence with Unmanned Aerial Vehicles (UAV)

(71) Applicants: Darren Thomson, (US); Milad Sakiani, (US); Christopher Mitchell, North Vancouver (CA)

(72) Inventors: Christopher Mitchell, North Vancouver (CA); Darren THOMSON, White Rock (CA); Milad Sakiani, Vancouver (CA)

(73) Assignee: Bigfoot Technologies Inc., White Rock (CA)

(21) Appl. No.: 15/816,675

(22) Filed: Nov. 17, 2017

(51) Int. Cl. B64C 39/02; A01M 29/10; A01M 29/16; A01M 29/18

(52) U.S. Cl. CPC B64C 39/024; A01M 29/10; A01M 29/16; A01M 29/18; B64D 2203/00; B64C 2201/108; B64C 2201/12; B64C 2201/146; B64C 2201/104

(57) ABSTRACT

An apparatus for sustained surveillance and/or deterrence of animals, such as birds, from an area, comprising one or more unmanned aerial vehicles (“UAVs”) controlled autonomously or remotely or with minimal human intervention and having a plurality of deterrence capabilities, including but not limited to flight path changes, movement changes, flight speed changes, visual projections and audio projections.

### BACKGROUND OF THE INVENTION

### Field of the Invention

Birds in particular cause a lot of unwanted damage to industrial, public and agricultural sites. Traditional methods of deterrence insufficiently address the issue and can be too costly. These can include, but are not limited to, netting, propane cannons, the presence of predatory birds, auditory devices projecting bird distress and other sounds, lights and other visual deterrents, actively moving vehicles and people, orchard pistols and manual UAV flights.

The invention relates generally to a bird deterrence apparatus that performs non-lethal methods of bird dispersal of nuisance birds. More specifically, this apparatus comprises one or more unmanned aerial vehicles capable of a plurality of deterrent techniques, some of which are inherent in the abilities of the unmanned aerial vehicle and others which are uniquely integrated as payloads. The utility of the invention is further increased by communication with landing and charging areas and, in some cases, remote monitoring and control interfaces.

PCT/NL2014/050306 discloses a method and apparatus for deterring birds with a fixed structure laser that can moved and controlled. U.S. Pat. Nos. 6,625,918 and 6,575,597 additionally disclose a bird deterrent apparatus with a laser. U.S. Pat. No. 7,841,291 discloses an animal repellant horn.

PCT/CA2013/000442 discloses a method of remotely controlling a plurality of unmanned aerial vehicles.

PCT/WP2015/050901 discloses an apparatus and method for electrically charging energy storage devices.

It is an object of this invention to be capable of automated (or nearly automated), unmanned operation and be reliably effective as an avian repellent in a wide range of conditions.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1: a top plan view of a specific configuration according to the invention;

FIG. 2: a high-level flow chart of the sequence of operations for the invention;

FIG. 3: a component view of a standard UAV;

FIG. 4: a component view of a standard computing device;

FIG. 5: a component view of a landing area, in accordance with some examples of the present disclosure;

FIG. 6: depiction of a UAV in direct communication with a computing device which is also in communication with central control communication device.

### DETAILED DESCRIPTION

Examples of the present disclosure relate generally to UAVs and specifically to a system of UAVs, landing and charging areas and enablement of automated (or nearly automated), unmanned operations for reliably effective animal repellence in a wide range of conditions. The system may incorporate a number of features to detect and deter animals, acquire internal and external information to determine safe flight conditions, extend the autonomy of the UAVs and communicate with a remote monitoring and control computing device.

To simplify and clarify explanation, the disclosure is described herein as an apparatus for enabling UAVs to provide sustained avian repellence. One skilled in the art will recognize, however, that the apparatus is not so limited. It should be understood that the apparatus may just as easily be used for other sustained surveillance and monitoring services.

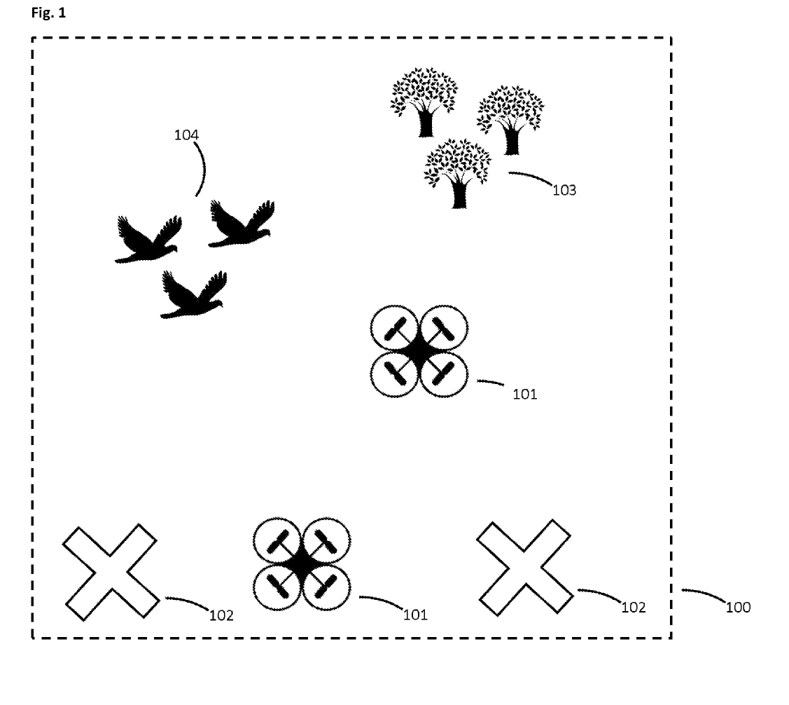

FIG. 1, depicts an example of a configuration of the invention where an area 100 is being monitored by two UAVs 101, in the presence of birds 104. From the top view, the area 100 is depicted as rectangular, but the shape and size are variable and the purpose is to define a three-dimensional airspace where the apparatus is operationally bound. The intent of the UAVs 101 is to deter the birds 104 from damaging or eating fruit from the trees/bushes 103. The birds 104 and trees/bushes 103 are not part of the apparatus, just examples to illustrate the purpose of the invention, however the environments in which surveys and deterrence operations take place could also be, but is not limited to, parks, golf courses, agricultural crops and buildings. The presence of landing areas 102 is also depicted.

In the preferred embodiment, these landing areas 102 have the ability to communicate via telemetry with the UAVs 101 and the UAVs 101 have the ability to navigate and land at the landing areas 102. The landing areas 102 can have different shapes or forms and the primary purpose is for extending the autonomy of the UAVs 101 by enabling recharging of the batteries or power source or swapping the power source or refueling. A secondary purpose of the landing areas 102 is for housing the UAVs 101 when not in flight, to avoid bad weather, reset navigation systems, and await further instructions, among other things.

The ability to remotely control and monitor the UAVs 101 is done wirelessly and enabled through cellular, satellite, radio frequency, wireless local area networking, or other wireless communication means, and this is assumed, but not illustrated. The number and location of UAVs 101 and landing areas 102 can vary greatly depending on the size of the area 100 and the needed persistence of surveillance and deterrence, taking into account that UAVs 101 are not performing their productive, desired task 100% of the time; time is consumed charging and refueling, taking off, landing and time to reach desired destinations within the area 100.

The flight paths of the UAVs 101 within the area 100 may be predefined or may be derived from predefined criteria, such as ensuring certain locations are reached and surveyed at a certain frequency or to specifically target the location of animals or birds 104. One or more UAVs 101 may be in flight at a given time. While flying, the UAVs 101 may periodically turn on and off various additional deterrents. The plurality of deterrence capabilities are embedded or emitted from within the UAVs 101 and are not uniquely identified in this diagram. One issue with traditional deterrents is predictability and adaption by the nuisance animals. The apparatus described is capable of generating several permutations of deterrents on a scheduled or random basis. These can include, but are not limited to, flight path changes including speed changes, heading changes, rotational changes, and altitude changes. In one example, the UAVs 101 can be made to resemble birds of prey. Additionally, the UAVs 101 are equipped with controllable payloads that may include visual and audio projections, such as lasers, distress calls, loud noises, among other things.

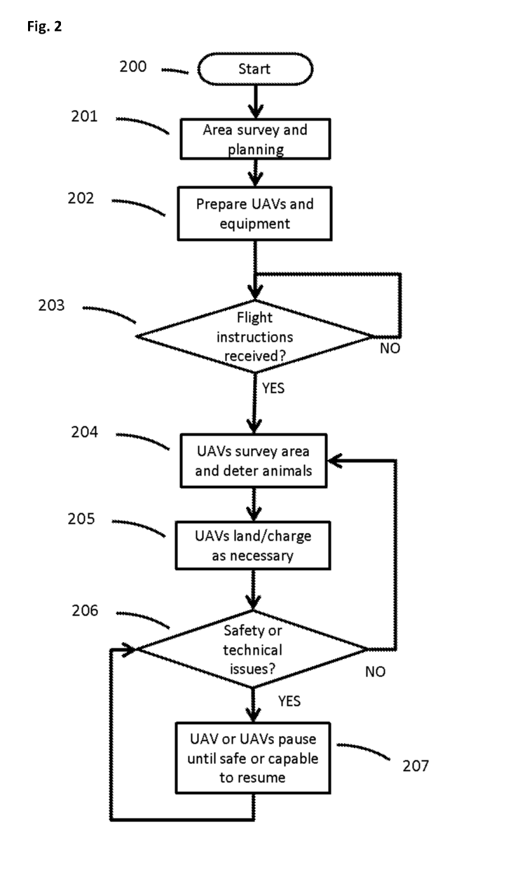

FIG. 2 depicts a flow chart of a logical sequence of activities for operation of the invention; it is understood that slight changes in the sequence of activities does not necessarily change the overall purpose or intention of the invention. 200 is the initiation of a deployment of the system. 201 indicates an initial survey of the area and corresponding planning activities; this may be a combination of manual activities aided by satellite maps, on-site photographs and visual assessment of the area and surrounding land and airspace to determine input variables for the system to operate within. These variables may include the number of UAVs 101 required to successfully deter animals from the area 100, the number of landing areas 102 to be setup and their location, the boundaries of the flight area (both vertical and horizontal), locations of obstacles to avoid, connectivity and other parameters for the UAV, topographical variables such as the altitude of the ground at various locations relative to the landing areas and criteria required to commence flying.

202 indicates an initial setup of the UAVs 101 and landing areas 102 and completion of pre-flight checklists such as telemetry connectivity testing for each UAV 101 and landing area 102 and remote connectivity to all the UAVs 101 and landing areas 102. 203 indicates a decision for the setup UAVs 101; they begin in standby mode waiting for either an external command or fulfillment of pre-defined criteria to commence operation. 204 indicates that the UAVs 101 are now performing autonomous bird 104 deterrence in the area. In this stage, the UAVs 101 and landing areas 102 are communicating with each other and possibly with a remote computing device.

The overall invention will determine an optimal combination of simultaneous flights and emittance of deterrents based on the finite set of resources available. Said resources include the available flight time of each UAV 101 based on its power source at any given time. 205 indicates the action of certain UAVs 101 landing and charging and this information feeds back into the system continually to continue adequate animal deterrence. 206 indicates a component of the ongoing operation wherein safety and technical issues are constantly monitored and certain UAVs or the whole system may be paused or suspended in 207 until fixed, meaning that fulfillment of pre-defined criteria is achieved before resuming the loop operations from 204 to 205 to 206.

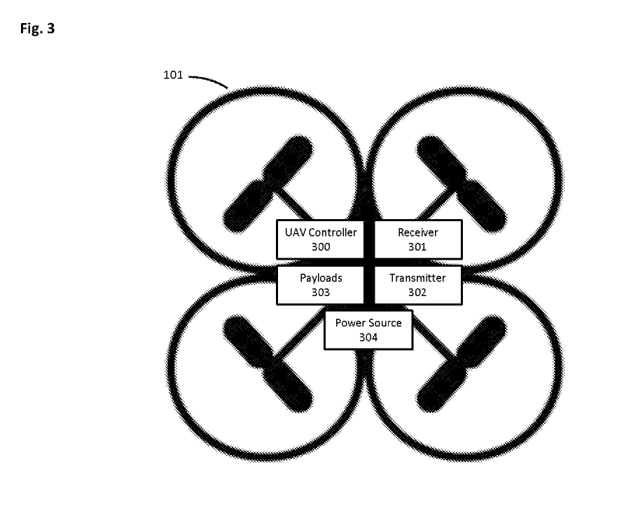

FIG. 3 depicts a common component view of a standard UAV 101, including a UAV controller 300, a receiver 301, a transmitter 302, various payloads 303 and a power source 304. A UAV 101 can take many shapes, forms and sizes, including the presence of a plurality or rotors or it may have fixed wings, or some combination. The UAV controller 300 typically includes navigational tools such as GPS for aiding in navigation, in this case, to ensure flights within the bounds of the area 100.

Payloads 303 conventionally include a conventional RGB camera to provide imagery, which may be used for navigational or other purposes, and can also include various sensors and controllable peripherals. Examples of such sensors include altimeters, laser or ultrasonic range finders, radars, and specialized cameras such as infrared and hyperspectral imagers. Examples of such controllable peripherals also include various audio and visual projectors as described in the disclosure. Another example of a payload could be for remotely sensing the presence of birds 104 or other aircraft or other objects, whereby the UAV 101 can take appropriate action, such as navigating towards or away from the detected object. The UAV 101 may also receive similar information about the presence of objects in the area 100 or vicinity from a connected device using its transmitter 302 and receiver 301, such as a computing device described in the disclosure.

While described as a power source 304, the power or energy source could also be a number of other sources, for example, a solar storage system, a fuel cell and a variety of different battery packs.

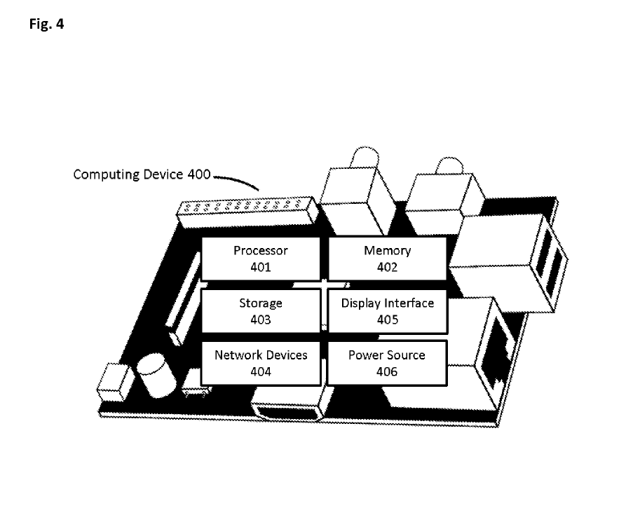

FIG. 4 depicts a standard computing device 400, which may be housed in an enclosure or envelope and may include a display. Such computing devices can be on small printed circuit boards or be available as standalone machines ready for direct human inputs and outputs; they include components of varying power like one or more processors 401, memory 402, storage 403, optionally a display interface 405, network devices or interfaces 404 (such as for communication to one or more networks or devices) and a power source or ability to draw power from an external source 406.

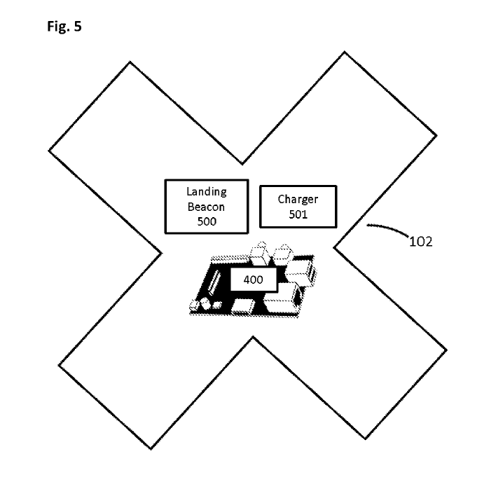

FIG. 5 depicts a landing area 102 in one embodiment containing a landing beacon 500, a charger 501 and a computing device 400. The shape and size of the landing area 102 can vary. The landing beacon 500 does not necessarily need to be tangible; it can simply be recognition of that particular location for navigation, such as GPS coordinates or a visual memory that can be communicated with the UAVs 101. In some examples, the landing beacon 500 can be or can generate a recognizable entity for a UAV 101 to identify and navigate towards. One specific example is a distinct pattern of infrared LEDs that are modulated at a known frequency, to distinguish landing areas 100 and not generate false positives from other natural or man-made objects.

The charger 501 is described as a conventional battery charger, but can be any method or apparatus to aide in transferring energy to a UAV 101, such as inductive, radio frequency, other non-contact charging systems and battery or fuel exchanges.

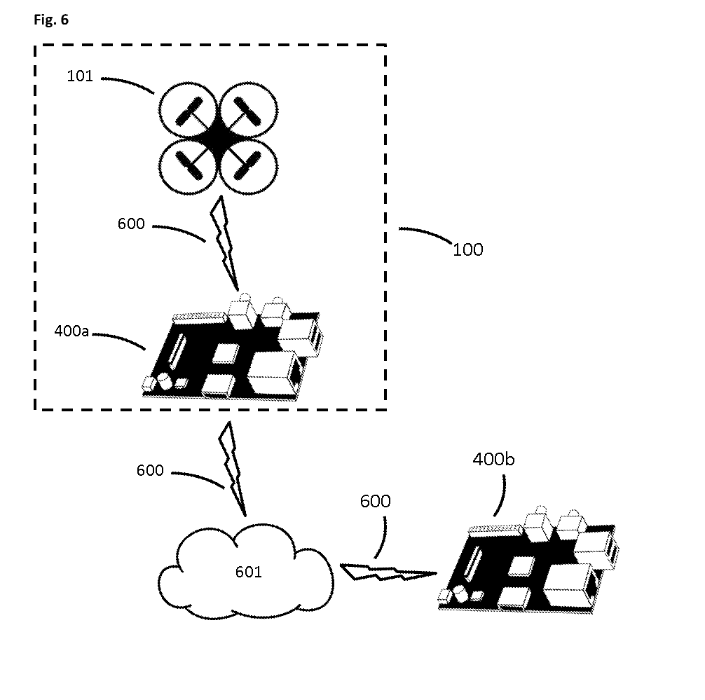

FIG. 6 depicts an example of connectivity and communication between components described in the disclosure. A UAV 101 communicates 600 to a computing device 400a, all of which are within the bounds of a defined area 100. Further, computing device 400a can communicate 600 with an intermediary network 601, such as the Internet, which communicates 600 with a central control computing device 400b or directly with a central control computing device 400b.

The computing device 400a can be a component of a landing area 102 and it is connected, either continuously or periodically through wired or wireless connections to one or more UAVs 101 and the central control computing device 400b. The central control computing device 400b may or may not be located in the area 100 or in the vicinity of the area 100. The central control computing device 400b may be connected to one or more computing devices 400a in one or more distinct areas 100.

The object of the central control computing device 400b is to achieve an overall view of the state of each UAV 101 and each landing area 102 in each area 100. This is useful for ensuring safety, monitoring the overall effectiveness and state and health of the system and sending commands to UAVs 101 and landing areas 102. This overall view enables the central control computing device 400b to programmatically determine an effective use of resources to achieve the desired surveillance and monitoring of multiple areas 100. Further, it is possible for a human to also monitor the system via an interface, sometimes graphically via a display, and send commands to one or more UAVs 101 and one or more landing areas 102. Some examples of commands include, but are not limited to, stopping flights or landing for safety or malfunction or adjusting flight variables or deterrence variables.

The specific configuration, size and shape and plurality of various elements can be varied according to particular design specifications or constraints requiring an apparatus or component of said apparatus according to the principles of this disclosure. Such changes are intended to be embraced within the scope of this disclosure. The presently disclosed examples, therefore, are considered in all respects to be illustrative and not restrictive.

### DESCRIPTION OF THE PREFERRED EMBODIMENT

Although the invention has been described in connection with a preferred embodiment, it should be understood that various modifications, additions and alterations may be made to the invention by one skilled in the art without departing from the spirit and scope of the invention as defined in the appended claims.

The embodiments of the invention in which an exclusive property or privilege is claimed are defined as follows:

1. An apparatus for sustained surveillance and/or deterrence of animals, such as birds, from an area, comprising one or more unmanned aerial vehicles (“UAVs”) controlled autonomously or remotely or with minimal human intervention and having a plurality of deterrence capabilities, including but not limited to flight path changes, movement changes, flight speed changes, visual projections and audio projections.

2. Apparatus according to claim 1, wherein the UAVs are some combination of rotary or fixed wing vehicles or a vehicle capable of both horizontal and vertical thrust.

3. Apparatus according to claim 2, wherein one or more deterrence capabilities are integrated within the UAV, physically and including a control interface.

4. Apparatus according to one of the preceding claims, wherein the UAVs have a means of detecting the presence and location of the target animals through visual and/or remote sensing, either directly or indirectly from information sent wirelessly from an external source.

5. Apparatus according to claim 4, wherein a subset of the deterrence capabilities are enabled and disabled by rule-based and adaptive algorithms based on said presence and location of said target animals.

6. Apparatus according to one of the preceding claims, wherein a subset of the deterrence capabilities are enabled and disabled in a predetermined or random fashion.

7. Apparatus according to one of the preceding claims, wherein the UAVs utilize one or more landing areas, including a computing device, which have the capability to extend the autonomy of said UAV by charging the accompanied battery or power source or swapping the power source.

8. Apparatus according to one of the preceding claims, wherein the area is a defined airspace comprising vertical and horizontal boundaries and the UAVs stay within said boundaries through real-time location acquisition, such as GPS.

9. Apparatus according to one of the preceding claims, wherein a remote or in area computing device is configured to: capture real-time vehicle status data of each UAV, including vehicle location data; display at least a subset of said vehicle status data for one or more of the UAVs, the displaying comprising a graphical or textual representation on an interface.

10. Apparatus according to claim 9, wherein said computing device comprises a control interface capable of sending control commands to one or more of the plurality of UAVs.

11. Apparatus according to claim 10, wherein said computing device is configured to: capture real-time data from said landing areas, including power source charging status; display at least a subset of said landing area data of each landing area; comprise a control interface capable of sending control commands to one of more of said landing areas.

12. Apparatus according to claim 10, wherein said computing device is configured to receive 3rd party data, which may include weather feeds, video of the area, air traffic control alerts, manned or unmanned vehicle presence alerts.

13. Apparatus according to claim 12, wherein said computing device can be configured to automatically send control commands to one of more of the plurality of UAVs or landing areas based on predetermined rules or algorithms associated with said 3rd party data.

14. Apparatus according to one of the preceding claims, wherein the deterrence capability of said flight path or movement changes comprise one or more changes in UAV speed, altitude, heading or rotation.

15. Apparatus according to one of the preceding claims, wherein the deterrence capability of said visual projections comprise one or more lasers or light emitting diodes or other light sources.

16. Apparatus according to one of the preceding claims, wherein the deterrence capability of said audio projections comprise one or more electronic whistles, piezo electric speakers, ultrasonic emitters or an audio system capable of emitting bird and animal distress calls and loud gunshot style noises.
